(19) United States
(12) Patent Application Publication
(10) Pub. No.: US 2011/0132561 A1
(43) Pub. Date: Jun. 9, 2011

(54) METHOD AND DEVICE FOR DETECTING AT LEAST ONE VARIABLE AT LEAST INDIRECTLY CHARACTERIZING THE PROPERTIES OF A SURFACE IN A MATERIAL WEB TREATMENT DEVICE AND METHOD FOR OPTIMIZING THE OPERATING METHOD OF A MATERIAL WEB TREATMENT DEVICE

(76) Inventor: Rudolf Münch, Konigsbronn (DE)

(21) Appl. No.: 12/747,982

(22) PCT Filed: Oct. 9, 2008
(86) PCT No.: PCT/EP2008/063525

§ 371 Date: Oct. 13, 2010

(30) Foreign Application Priority Data
Dec. 14, 2007 (DE) 10 2007 055 820.3

(51) Int. Cl. G01N 21/55; G01B 11/24; G01N 21/84; G01B 11/30; H04N 7/18; D21F 11/00

(52) U.S. Cl. 162/198; 356/445; 356/612; 356/429; 356/600; 348/88

(57) ABSTRACT

A method for detecting at least one value at least indirectly characterizing the properties of a surface in a material web treatment device. The method includes the steps of illuminating the surface at least at two measuring points with at least one emission source, simultaneously detecting at least one value at least indirectly characterizing a reflectivity of the surface at said each of the at least two measuring points with a detector device and evaluating the reflectivity.

### BACKGROUND OF THE INVENTION

1. Field of the Invention

The present invention relates to a method and a device for detecting at least one value characterizing at least indirectly the properties of a surface in a material web treatment device by analyzing the reflectivity of the surface. The present invention further relates to a method for optimizing the operating mode of a material web treatment device.

2. Description of the Related Art

Material webs, especially fibrous webs in the form of paper, cardboard or tissue webs are known in the state of the art in a multitude of embodiments. Depending on individual applications, the surface characteristics are important, especially the gloss and the printability. The gloss is an optical property of a surface which is characterized by the ability to reflect light. Measuring of gloss with known reflection measuring systems in the surface area of the fibrous web occurs through determination of the reflection in a very defined angle of normally either 45° according to DIN-Standard 45402 or 75° according to TAPPI T480. Therefore a dedicated measuring device is still necessary for each measuring point in a machine for the production of a fibrous web, especially in web treatment devices which process the surfaces. In this context we refer to a company-issued documentation entitled “Gloss” by Zehntner GmbH Testing Instruments, CH-4450, www.zehntner.com. This paper discloses the basis of acquiring surface properties of webs, especially the gloss, as well as the criteria for selection of the correct measuring geometry.

Another possible method of measuring the parameters which determine the surface characteristics, especially the smoothness, is described in J. S. Arney, Hoon Heo and P. G. Anderson: “A Micro-Gonio-Photometer and the Measurement of the Print Gloss”, Journal of Imaging Science and Technology, Vol. 48. No. 5, September/October 2004. This article discloses the measurement method by means of a Micro-Gonio-Photometer, whereby the surface which is to be measured, especially the web, is placed around a roll so that several reflection angles can be measured at the same time.

In converting equipment in the form of calendars, a plurality of rolls which form glazing nips act successively upon the web through utilization of steam, water, temperature and pressure. The web is run through a plurality of converting units. Measurement only takes place at the end of the calendering process, in other words after the last converting unit. The measurement contains the effects of all individual processing steps in the individual converting units in a superimposed form. Evaluation of the individual converting steps is therefore typically difficult. Optimization of the individual converting steps, in other words of the individual converting units inside the converting equipment, is not possible on this basis.

What is needed in the art is a method for evaluation of individual converting steps in a web treatment device by utilizing simple means and low control-technological expenditure. The measurements required to determine a value which characterizes the surface properties of a web should be achievable at a minimum expenditure.

### SUMMARY OF THE INVENTION

The present invention provides a method for detecting at least one value which characterizes the properties of a surface in a fibrous material web treatment device, at least indirectly, by evaluating the reflectivity, for example the degree of reflection, is characterized in that at least one emission source illuminates the surface at least at two measuring points and that at least one value characterizing the reflectivity, for example the degree of reflection at least indirectly, is detected simultaneously at individual measuring points with a detector device.

With the method according to the present invention it is possible to detect at least one value characterizing the reflectivity of the surface, at last indirectly, and thereby a value describing the surface quality during the operation of the material web treatment device in various converting units which provide the measuring points, so that the detected actual values also allow an evaluation of the operating mode of the individual converting units within a material web treatment device and, in addition, provide a basis for the activation of the control devices allocated to these converting units. The expenditure for the detection of values is low due to the utilization of a detector device.

Measuring points are dotted, lined or flat areas where the surface is scanned. The degree of reflection indicates how much incident radiation is reflected. Normally a portion is reflected and/or absorbed by the web.

The values characterizing the properties at least indirectly, are values which describe either the properties directly or values which have a functional connection with the values characterizing the surface properties. This means, characteristics can be derived from these values, for example through mathematical calculation or empirically determined characteristics or parameters.

A variety of possibilities exist regarding the location of the measuring points for detection of a value which characterizes the surface reflectivity, at least indirectly. They may be located directly adjacent to each other, or also at a distance from each other in a longitudinal and/or transverse direction of the converting unit. The longitudinal direction describes the travel direction of the web and is also referred to as the machine direction. The transverse direction is consistent with the width direction of the converting unit. In addition, measuring points which are offset in the longitudinal direction of the converting unit may also be arranged offset in a height direction, so that a totally different measuring geometry results for the individual measuring points. The measuring geometry is characterized by the distance between the measuring points and the emission source, the distances between the measuring points and the detector device, as well as by the positioning of the detector device and emission source.

According to a first embodiment of the present invention the detection occurs at least two measuring points which are located at a distance from each other in the longitudinal machine direction of the converting unit. This solution is useful in web converting units which are located behind each other, since the detected actual values can be utilized to control the operating mode during the travel of the web.

The detection of a value characterizing the reflectivity of the surface at least two measuring points which are located at a distance in the cross direction to the machine direction offers the advantage of being able to monitor the web characteristics also in cross machine direction, to an optimum level. According to a second embodiment of the present invention, the detection occurs at a plurality of measuring points across the machine width in order to determine a cross profile, whereby this is controllable based on the variance between the detected actual values and the required desired set points.

Detection occurs by only one detector device including at least one image capturing detection device whereby the images are evaluated in an evaluation system. The analysis can occur immediately following the detection of these values. The detection occurs by an image recording device, for example a camera, whereby a local resolution greater than approximately 10 cm per measuring point is selected. This is to be understood that, for example on a 10 m wide web, at least 100 qualitative values (for example gloss) can be determined across the web width.

According to a third embodiment of the present invention, an image recording device is used to record several measuring points simultaneously in the longitudinal and/or the cross machine direction at a predefined resolution, for example greater than 20×20 pixel, through appropriate image segments. However, an image recording device having sufficient predefined pixel resolution would preferably always be used, so that a certain predefined width of the measuring point is imaged, for example larger than 1 m.

The detector device used according to the present invention is designed so that different angles of reflection can be detected simultaneously at least at one of the measuring points and/or at the individual measuring points. This is useful for routing the web over curved surfaces such as rolls, or for the determination of the surface quality of material web rolls. With regard to equipment a Gonio-photometer may be used.

A measurement concerning the strength of the reflection, for example the degree of reflection is, for example, detected as the value which characterizes the reflectivity at least indirectly.

For a real time integration of the measured quantities in control and/or adjustment processes, the detection at the individual measuring points occurs continuously. However, detection of the values characterizing the properties of the surface, at least indirectly, is also conceivable at pre-defined time intervals.

The method according to the present invention is suited to detect the reflectivity of a moving surface, for example a fibrous material web during operation of a material web treatment device. Here, the reflectivity of the surface of the material web in the direction of travel of the web is, for example, determined at the measuring points which are located at distances from each other and the change in the reflectivity on the surface between the two measuring points is captured, whereby variances in the changing characteristic between the measuring points could be construed as circumstantial evidence of malfunction or an operating mode of one converting unit which is not optimized.

According to a fourth embodiment of the present invention, the reflectivity of a rotating surface in the embodiment of a roll and/or a fibrous web material roll can, for example, be used for diagnostic purposes.

As the values characterizing the properties of the surface at least indirectly, gloss, roughness, and printability, among other properties may be determined as functions of the reflectivity.

The method according to the present invention for optimization of the operating mode of a material web treatment device is characterized in that at least one value characterizing the properties of the surface in a material web and/or a component of the web treatment device, at least indirectly, is determined during operation of the material web treatment device at different measuring points so that the surface at the at least two different measuring points is illuminated by an emission source and that at least one value characterizing the reflectivity of the surface, at least indirectly, is detected simultaneously at the individual measuring points and that the value characterizing the properties of the surface, at least indirectly, at the individual measuring points is set as an input value for the control and/or adjustment of a value characterizing the operating mode of the material web treatment device. The simultaneous actual value detection in different converting units allows optimum monitoring of the operating mode of a material web treatment device accommodating these.

A change in the value characterizing the properties of the surface of a material web, at least indirectly, may be detected whereby the web treatment device is controlled depending upon the changing characteristic in order to achieve a homogenous material web surface.

A treatment of the moving surface, for example the material web surface, occurs in the web treatment device through at least one of the following measures:

Change of temperature;

Change of pressure;

Moistening; and

Vaporization.

If a calender is used as a material web treatment device which includes a plurality of glazing cylinders which respectively form a glazing nip, the measuring points may be provided on different glazing cylinders or guide rolls. Depending on a variance of an actual value for the surface quality, a regulating value can be produced to control at least one of the following components of the calender:

Steam blow box;

Steam-water spray device;

Water spray device;

Roll temperature; and

Load in roll nip, especially pressure profile.

If the web treatment device, for example, is in the embodiment of a winder for a material web roll, at least one value characterizing the properties of the surface of a material web roll and/or a roll in the winder, at least indirectly, is detected at the winder and then used as an input quantity for a control of the winder. Depending upon a value describing the properties of the surface of a material web roll and/or one of the rolls in the winder, at least indirectly, one of the following parameters in the winder is controlled:

Speed of the carrier roll; and

Contact pressure in the winding nip

Prior to starting the material web treatment device, an initial state may be pre-defined and a measurement of one value characterizing the surface of the material web, at least indirectly, is taken at the measuring points, and a change in this compared to the initial state is monitored. Comparative values of the initial state may be freely defined.

According to a fifth embodiment of the present invention, an adjustment of the material web treatment device can be viewed as an initial state by means of which a small influence upon the surface properties of the material web can be produced.

An alternative possibility is to view a condition as initial state without passage through the machine of a material web and to cover the evaluating measuring points in the measuring area with a material which possess a known and an as homogeneous as possible surface characteristic. The reference measurement is taken with this cover. In addition, the surfaces of a roll which is not yet wrapped by the fibrous material web can be used to define the initial state.

The individual measuring results which represent the actual values at a given point in time can be continuously detected and can, for correlation purposes, be compared with pre-defined measuring values of a standard measuring system inside the machine or in a laboratory. The differences in the measuring geometry in consideration of more than one measuring point with the same detector devices can be compensated in the measured results with suitable means, whereby reference measurements and/or theoretical models and/or already known experimental steady state characteristics are used.

According to a sixth embodiment of the present invention, the reflectivity of the surface is evaluated at various wave lengths or spectra. In the method according to the present invention, at least one qualitative value of the material web, for example gloss, smoothness, printability, blackening and/or fiber orientation is also determined from the reflectivity of the surface. Here, additional available measured values from other measuring devices or data sources, such as surface related dimensions, moisture, temperature, thickness, formation, composition, gloss, smoothness, roughness, printability, blackening and/or fiber orientation and additional information can be used in order to more precisely evaluate the qualitative values by considering and linking the respectively relevant information.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows in a simplified schematic illustration the basic construction of an device according to the present invention for detection of a value, characterizing at least indirectly, the properties and/or quality of a surface in a web treatment device;

FIGS. 2a and 2b show examples of the detector device;

FIG. 3 shows the arrangement of the device according to the present invention for the detection of at least one value characterizing, at least indirectly, the properties and/or quality of a surface in a calender unit;

FIGS. 4a and 4b show feasibilities of measurement in a cross direction of the surface;

FIG. 5 illustrates processing of the detected values with the assistance of a block diagram;

FIG. 6 illustrates the function mode of a Gonio-photometer;

FIG. 7 illustrates a method for optimization of the operating mode of a web treatment device according to the present invention with the assistance of a signal flow diagram; and

FIG. 8 shows an additional method for optimization of the operating mode of a web treatment device according to the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

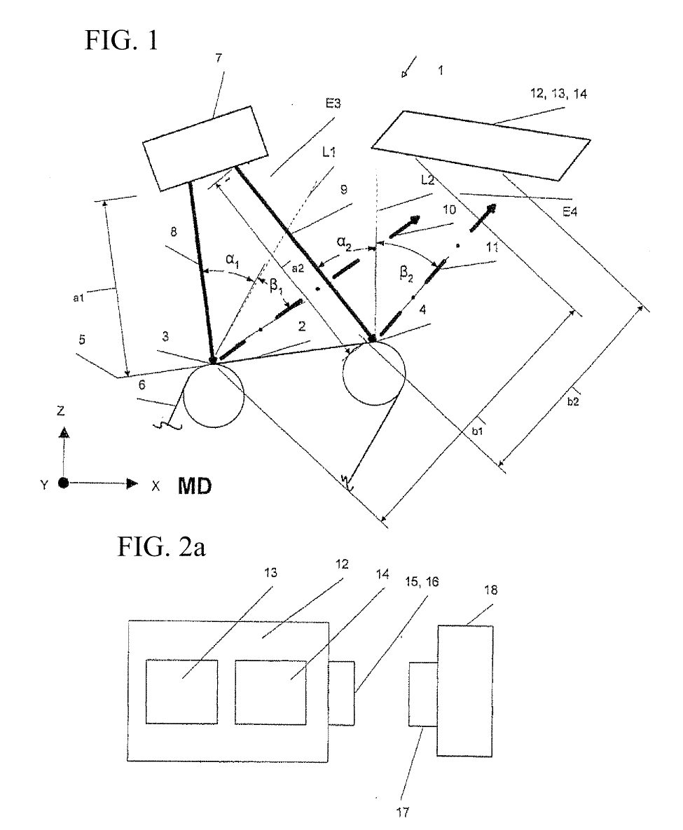

Referring now to the drawings and, more particularly to FIG. 1, there is shown a simplified schematic illustration of the basic construction of inventive device 1 for detection of at least one value characterizing, at least indirectly, the properties and/or quality of surface 2 derived from its reflectivity. Device 1 hereby serves to detect these values at least two different measuring points 3 and 4 which are located at a distance from each other in material web treatment device 5 for material web 6. Depending upon size and orientation, measuring points 3, 4 can describe dotted, lined or flat areas. Each individual measuring point 3, 4 can be described by coordinates in a fixed coordinate system XYZ. Coordinate system XYZ is determined relative to an apparatus or a device in which the reflectivity of surface 2 is to be determined. If, according to an embodiment of the present invention surfaces 2 are surfaces of material webs 6, for example in the form of fibrous webs, for example paper, cardboard or tissue webs and are, therefore, surface 2 which is moved by a machine, then coordinate system XYZ is determined by respective web treatment device 5 and thereby a part of the machine for the production of such webs in which at least one value characterizing the properties and/or the quality of surface 2 of material web 6, at least indirectly is detected. The X-direction is described by the travel direction of material web 6 which is also consistent with the longitudinal machine direction. This is also referred to as machine direction MD. The Y-direction describes the direction transverse to the longitudinal machine direction MD and is also referred to as CD.

FIG. 1 is a schematic simplified illustration of a view from the right of the basic construction of device 1 to detect a value characterizing the properties of surface 2, at least indirectly, which is allocated to web treatment device 5. Device 1 includes at least one emission device 7, for example in the form of a light source. Light source 7 is selected and designed so that it is suitable for illumination of surface 2 at both measuring points 3 and 4. Distance a₁ describes the distance between emission device 7 and measuring point 3. Distance a₂ describes the distance between emission device 7 and measuring point 4. Incident light rays 8, 9 occurring on surface 2, emitted from emission device 7 impinge on surface 2 at measuring points 3 and 4 which are located at a distance from each other in machine direction MD. Surface 2 of material web 6 is a moving surface. On this surface incident light rays 8, 9 are reflected, at least partially. Light rays 8, 9 impinge at a slant on surface 2, that is at an angle of incidence α₁ at measuring point 3 and at an angle of incidence a₂ at measuring point 4. Angle α is measured on the surface relative to a vertical plane, axis of incidents L, in this case L₁ and L₂. Light rays 8, 9 at two measuring points 3, 4 are reflected in this area on surface 2 and the reflected light rays 10, 11 emerge again in a so-called angle of reflection β₁ and β₂ respectively. Individual angle of reflection β₁ or β₂ respectively is also determined relative to vertical L₁ or L₂ respectively on surface 2. Incident light rays 8, or 9 respectively, verticals L₁, L₂, as well as emergent or reflected rays 10, 11 are located in one plane. For measuring point 3 they are in plane E₃ and for measuring point 4 they are in plane E₄. Depending upon the opacity of surface 2, light rays 8, 9 can either be reflected completely, or a part is transmitted and absorbed.

Reflective light rays 10, 11 are captured by detector device 12 which is allocated to both measuring points 3 and 4. Detector device 12 may be in various embodiments. It may be an image capturing device 13. Image capturing device 13 may, for example, be in the embodiment of a camera with which reflected light rays 10 or 11 respectively are captured simultaneously for individual measuring points 3 and 4, whereby the relationship between image detection 13 and measuring points 3 and 4 is provided by an appropriate coordinate unit 14 and a precise allocation of the reflection values that can be detected and derived from emergent light rays 10, 11 is made possible. The surface quality of surface 2 in the area of measuring points 3, 4 can be described as a function of the reflectivity, for example degree of reflection RG in the area of measuring points 3, 4.

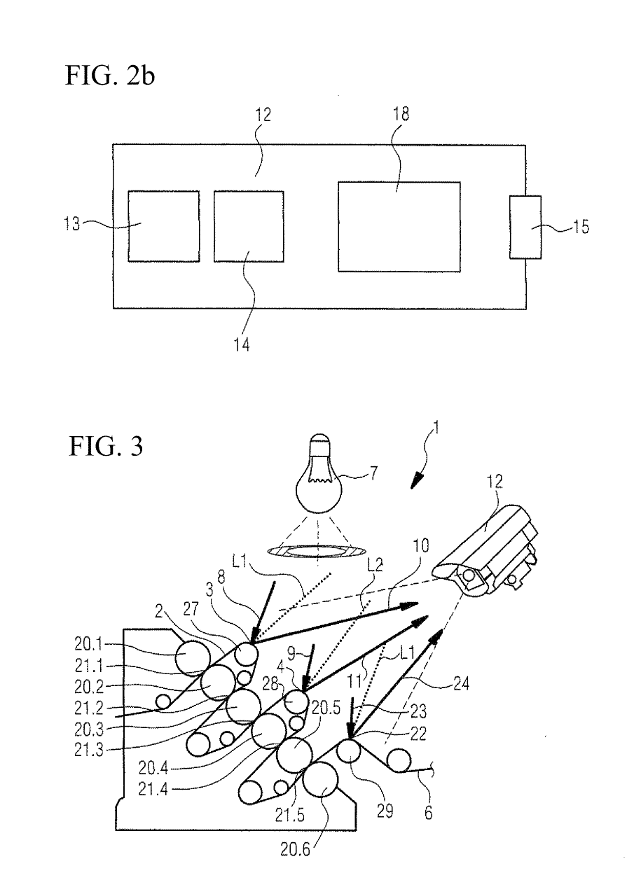

Depending upon the type of image processing, various options exist regarding the further design of detector device 12. According to a first embodiment shown in FIG. 2A this may be equipped only with image capturing device 13 and with coordinate unit 14 and interface 15 in the form of a communication interface, for example for immediate transmission of the determined information. Interface 15 includes, in this case, at least one transmitter 16 which transmits the detected parameters to receiver 17 of image processing device 18. Receiver 17 may be integrated in separate unit 18, located at a distance from detector device 12.

In contrast, FIG. 2b illustrates one embodiment of detector device 12 with integrated image processing unit 18. This includes image capturing device 13 and coordinate unit 14 for individual measuring points 4 and 3, whereby coordinate unit 14 may form one component unit with the detection device. In the current example image processing unit 18 is integrated into detector device 12 which means that an image detection, storage and evaluation can already occur here. Detector device 12 also may be provided with communication interface 15 from which the characteristic values determined by image processing can be read.

FIG. 3 illustrates one specific application of device 1 for the detection of at least one value characterizing the properties, for example the quality of surface 2 of a fibrous web, at least indirectly, in calender 19. “Characterizing at least indirectly” means that in effect it need not be the value directly, but may also be a value describing property parameter which, for example, has a direct functional or proportional connection with the values. The illustration shows an example of calender 19 for calendering material web 6. Calender 19 includes a plurality of glazing cylinders 20.1 whereby always two together forms glazing nips 21.1 through 21.5. The material web passes through glazing nips 21.1 through 21.5 and is subjected to a surface treatment. Treatment of material web 6 in glazing nip 21.1 through 21.5 can be described by different process parameters, for example pressure p and temperature T. These measures convert web 6 in regard to its surface during its run through calender 19. Between glazing nips 21.1 through 21.5 the web passes over guide rolls—here for example identified for three measuring points 3, 4, 22 with 27, 28 and 29. The surface properties change from entry into calender 19 in the direction of travel. In order to detect the change in the properties of surface 2 during the calendering process, for example gloss G achieved here, or roughness R, calender 19 is allocated to inventive device 1. In the illustrated example, three measuring points are provided. First measuring point 3, second measuring point 4 and third measuring point 22 which here are located at a distance from each other in machine direction MD of web treatment device 5 in the embodiment of calender 19. Machine direction MD of web treatment device 5 is determined by the direction of travel of the fibrous material web through it. Coordinate system XYZ is provided in the current example whereby direction X determines the progression in machine direction MD. First measuring point 3 is located in the area of entry or after passage through first glazing nip 21.1. Third measuring point 22 is located after last glazing nip 21.5 of calender 19 through which the web has to run. And second measuring point 3 is allocated to a converting station in between.

Emission device 7 emits light onto surface 2 of material web 6 at measuring points 3, 4 and 22. One can see the different distances between light source 7 and measuring points 3, 4 and 22, in other words the area of impact on surface 2, and also light rays 8, 9 and 23 which impact surface 2 at angle of incidence α₁, α₂ and α₃ which—in order to provide a clearer overview—is not illustrated. Light rays 8, 9 and 23 are reflected on surface 2 and light rays 10, 11 and 24 reflecting from this are detected by detector device 12. Detector device 12 in this case is in the embodiment of a camera. Also seen are the different distances between surface 2 at measuring point 3, 4 and 22 and detector device 12, as well as the different angles of reflection which, however are not identified here. From reflecting light rays 10, 11 and 12 at least one value characterizing the reflectivity of surface 2, at least indirectly, for example the degree of reflection at respective measuring point 3, 4 or 22 is detected through detection device 12 and a conclusion is drawn with regard to the parameters or properties of surface 2 of the material web at measuring points 3, 4, 22.

FIG. 3 illustrates an example of an embodiment where measurements are taken at measuring points 3, 4, 22 which are located at a distance from each other in the machine direction and thereby at different measuring pints within one web treatment device 5. From these individual measuring results allocated to measuring points 3, 4 and 22 which, as a rule are further evaluated, a conclusion can be drawn regarding the functional mode and the optimization possibilities of the operating mode of material web treatment device 5. This is especially the case if the parameters which would be in accordance with the desired surface quality were not determined at measuring point 22.

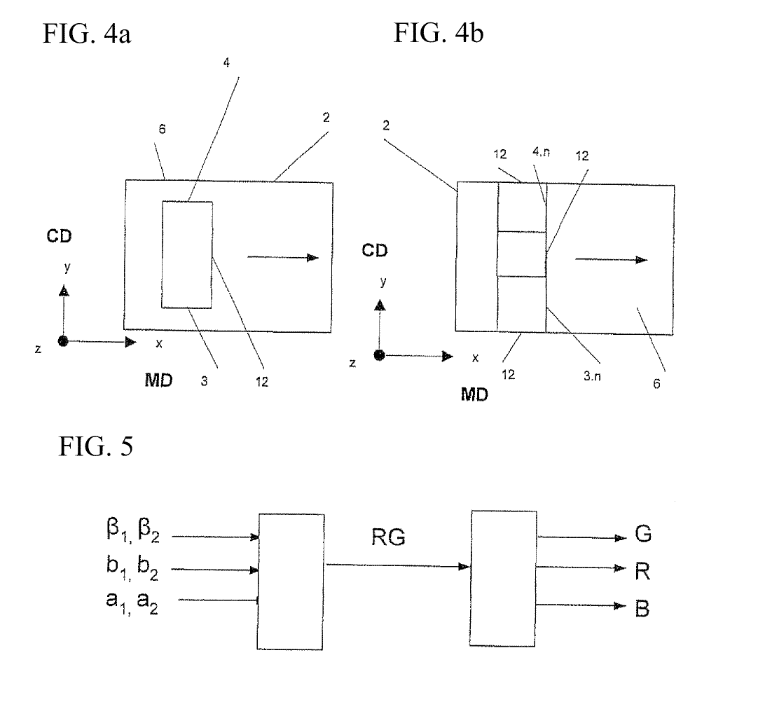

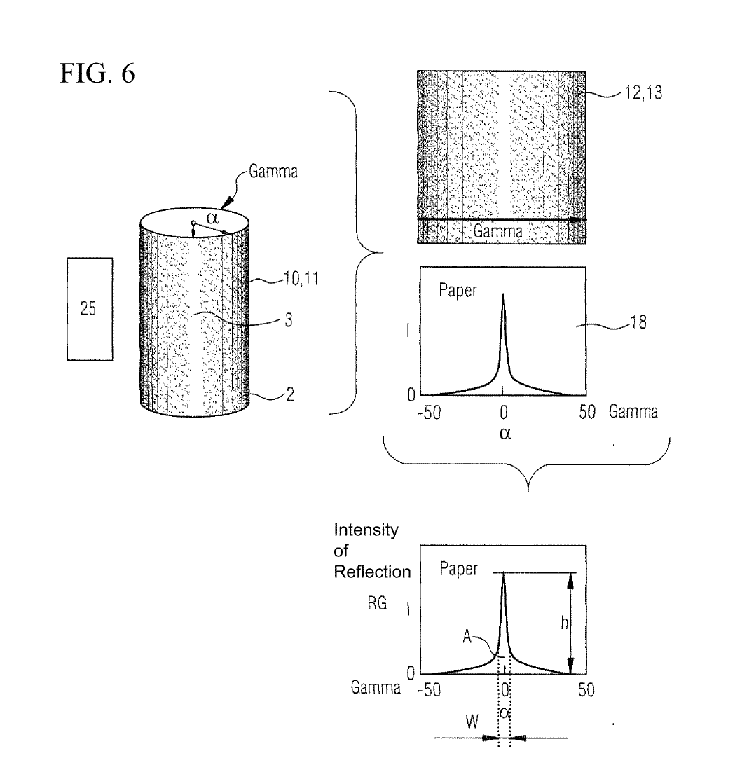

According to another embodiment, measuring points 3, 4 and possibly 22 are not only provided in the machine direction, but measuring points 3, 4 and 22 are designed as measuring points which extend over a part of the machine width, in other words, transversely to longitudinal machine direction MD. This is consistent with Y-direction of the coordinate system on appropriate web treatment device 5. An example is shown in a simplified schematic illustration in FIG. 4a. Here, individual measuring points 3, 4 are measuring areas which extend over a part of the width of surface 2 which is to be evaluated. In order to monitor the entire width in accordance with the embodiment shown in FIG. 4b, at least two, or a multitude of detector devices 12 are located in cross direction CD to machine direction MD and permit image detection across the entire machine width in a measuring area which is characterized by like coordinates in machine direction MD. Because of this, information, for example regarding the gloss characteristic, can be gained across the entire surface width, for example the material web width. This is made possible through the construction of a cross profile.

The individual detector units 12 may be allocated to measuring area 3.n, 4.n which extends in cross direction CD, in other words transversely to the longitudinal machine direction.

As parameters to determine at least one value describing, at least indirectly, the properties or quality of surface 2, the values describing emergent ray of light 10, 11, at least indirectly, can be processed, for example the degree of reflection. This is shown in the example in FIG. 5 by way of a block diagram. From this it can be seen that for the input quantity for light rays 10 and 11 at least the reflection angle in form of angle of reflection β₁ and β₂ is determined as well as possibly the measuring geometry, that is the parameters describing the measuring arrangement, for example distance a of the emission source, as well as distance b between measuring points 3, 4 and detection device 12. In addition, parameters are determined from image detection device 13 from which a conclusion regarding the properties can be drawn. As properties for example, roughness R or gloss G of surface 2 can be determined as a direct function of degree of reflection RG.

Especially if surface 2 in the area of measuring point 3, 4 is curved, a so-called micro Gonio-photometer arrangement is utilized as detection device 12 according to the present invention. The micro Gonio-photometer is allocated to measuring points 3 and 4. The function of a micro Gonio-photometer is already known for example from “A Micro-Gonio-Photometer and the Measurement of the Print Gloss”, Journal of Imaging Science and Technology, Vol. 48. No. 5, page 458 ff. From this it can be seen that the individual light rays are projected by orientation device 25 onto measuring points 3 and 4 which is not shown here. As a result light rays impinge in the measuring area of measuring points 3 and 4 always in the same direction on surface 2. Here the coordinate system is moved into the center location of the curved surface. Direction X progresses through the diameter. Y-direction progresses in cross direction. The incident light rays are reflected on surface 2 and are emitted again as reflected light rays 10, 11. These are captured by image detection device 13, for example in the embodiment of a camera. An image is provided which is outlined depending on the gamma angle. This gamma angle is consistent with the main angle of inclination of curved surface 2.

A two-dimensional image is provided through the Gonio-photometer. The Gonio-photometer measures reflected light rays 10 and 11 as function of the angle between vertical L to surface 2 and detector device 12, the angle of emission source 7 to the vertical, that is the angle of incidence and the angle of reflection and/or the gamma angle of the gradient of surface 2. In dependence upon one of these values a two-dimensional reflection factor function can be generated which contains a certain progression over curved surface 2.

The possibilities described in the Figs. for detection of a value characterizing, at least indirectly, a reflectivity of surface 2 represent examples. It is important that detection of these values occurs simultaneously on at least two different measuring points 3, 4 and an evaluation is conducted. This presents various possibilities. Especially when arranging measuring points 3, 4 with the same coordinates in machine direction MD, a cross profile across the entire width can be produced in a simple manner. According to an additional embodiment of the present invention, the functional mode, for example of web treatment device 5, in the direction of travel of the material web can be evaluated. In addition, it is possible to detect changes in the functional mode of material web treatment device 5 in one measuring area and to actively act upon this, or to operate the line also in this area under consideration of desired pre-defined adjustable function parameters.

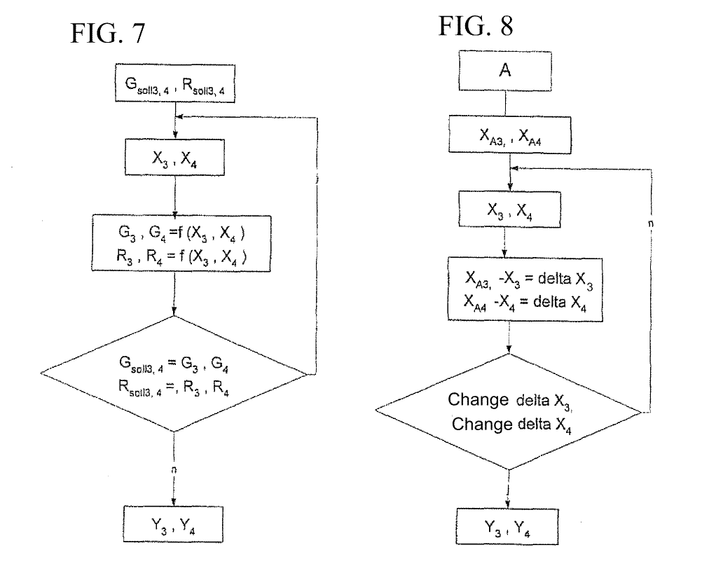

According to a first embodiment of the present invention in FIG. 7, the reflectivity of surface 2 is monitored at least at two measuring points 3, 4 which are located offset to each other in the longitudinal direction, in other words in MD direction of the machine and/or in cross direction, in other words in CD direction at measuring areas 3, 4. For this purpose, actual values of one or more values X₃′X₄ characterizing, at least indirectly, the reflectivity on surfaces 2 in the areas of measuring points 3 and 4 are continuously being monitored and detected by means of device 1. These are a function of gloss G or roughness RG of surface 2 in these areas and lead to actual values G₃ and G₄ or respectively R₃ and R₄. Depending upon provision of desired set point Rₛₒₗₗ₃, Rₛₒₗₗ₄ or respectively Gₛₒₗₗ₃, Gₛₒₗₗ₄, a comparison is made with the obtained values. If this comparison shows a variance, then manipulated value Y₃ and Y₄ respectively is determined for activation of converting units 5 in the area of measuring points 3 and 4. Since, for example in calenders 19, the function can be adjusted, for example through the pressures in individual glazing nips, as well as through the temperatures, varying measures can be taken in the individual measuring point areas 3 and 4. Here, a parameter change can occur in at least either only one measuring area 3, 4 or preferably in both. Regarding this the relevant measuring results are integrated into the control of the operating mode of calender 19.

According to FIG. 8, an initial state is predefined for each measuring point 3, 4. The initial state is identified as A. This predefined initial state is characterized by initial state characteristic values X_{A3} and X_{A4}. These are the basis for comparative or reference values for the subsequent process. They may be predefined or can be determined during the operation of the machine. We will refer to the determination in further detail below. The machine, or respectively web treatment device 5, is then operated in normal operation and the measurement of the actual values, at least of one of the values X₃, X₄ characterizing the reflectivity of surface 2, at least indirectly, at measuring points 3, 4 or respectively measuring areas occurs. This detection occurs continuously and a comparison occurs with values X_{A3}, X_{A4} characterizing the initial state A, whereby a variance values ΔX₃ and ΔX₄ is determined from the comparison, and is determined continuously. Depending upon a change in variance value ΔX₃ or ΔX₄ respectively, conclusions can be reached regarding a change in the surface properties of surfaces 2 currently running through calender 19, and thereby defects can be detected in material web 6 which is to be produced. Initial state A can be determined in different ways. According to a first embodiment, a reference measurement on surface 2 of the material web is taken only in operational step A at measuring points 3 and 4 in web treatment device 5. For this purpose, this is adjusted, for example, so that at least in one of measuring areas 3 or 4 as negligible an influence as possible is exerted upon material web 6. This may occur, for example, in calender 19 so that pressure p and temperature T in measuring area 3 are lowered over the actual normal operational state. It is also conceivable to take the measurement at startup of calender 19, when it has not yet reached the operational temperature.

An additional possibility to determine initial state characterizing value X_{A3} and X_{A4} exists in covering measuring areas 3 or respectively 4 with means that they have a known and an as homogeneous as possible surface characteristic. The reference measurement is taken at this cover. Here too the measurement is continued during normal operation of the machine and the signal change is monitored during normal operation and compared to the initial state. A further step can be added here as an option, whereby the reference measurement occurs with additional known materials.

According to an additional possible design the surface of the roll, for example the glazing cylinder, can be detected and can be defined as the initial state. In this case the material web has not yet run through calender 19.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### COMPONENT IDENTIFICATION

1 Device

2 Surface

3 Measuring point, measuring area

4 Measuring point, measuring area

5 Web treatment device

6 Material web

7 Emission device

8 Incident light ray

9 Incident light ray

10 Reflected light ray

11 Reflected light ray

12 Detector device

13 Image capturing device

14 Coordinate unit

15 Interface

16 Transmitter

17 Receiver

18 Image processing device

19 Calender

20.1-20.6 Glazing cylinder

21.1-21.5 Glazing nip

22 Measuring point

23 Light ray

24 Reflected light ray

25 Orientation device

27 Guide roll

28 Guide roll

29 Guide roll

A process step

a₁ Distance

a₂ Distance

a₃ Distance

B Printability

b₁ Distance

b₂ Distance

b₃ Distance

E₃ Plane

E₄ Plane

G Gloss

G₃ Actual value

G₄ Actual value

G_{soll3,4} Set point

L₁ Vertical

L₂ Vertical

L₃ Vertical

R Roughness

R₃ Actual value

R₄ Actual value

RG Degree of reflection

R_{soll3,4} Set point

X₃ Actual value

X₄ Actual value

X_{A3} Initial state value

X_{A4} Initial state value

Y₃ Manipulated value

Y₄ Manipulated value

α₁ Angle of incidence

α₂ Angle of incidence

β₁ Angle of reflection

β₂ Angle of reflection

1-41. (canceled)

42. A method for detecting at least one value at least indirectly characterizing the properties of a surface in a material web treatment device, the method comprising the steps of:
illuminating the surface at least at two measuring points with at least one emission source;
simultaneously detecting at least one value at least indirectly characterizing a reflectivity of the surface at each of said at least two measuring points with a detector device; and
evaluating said reflectivity.

43. The method according to claim 42, wherein said reflectivity is a degree of reflection of the surface.

44. The method according to claim 43, wherein said detecting step occurs in a converting unit of the material web treatment device and said at least two measuring points are located at a distance from each other in a machine direction of the material web treatment device.

45. The method according to claim 44, wherein said at least two measuring points are located at a distance from each other in a cross machine direction of the material web treatment device.

46. The method according to claim 45, wherein said detecting step at said at least two measuring points in said cross machine direction is used to determine a cross profile of the surface.

47. The method according to claim 46, wherein said detector device is at least one image capturing device, said detecting step including the steps of:
recording an image with said at least one image capturing device; and
evaluating said image in an evaluation system.

48. The method according to claim 47, wherein said at least one image capturing device is a camera having a local resolution greater than 10 cm per each of said at least two measuring points.

49. The method according to claim 48, wherein said at least two measuring points is several measuring points and said at least one image capturing device simultaneously records said several measuring points through a plurality of predefined segments at a predefined resolution in at least one of said machine direction and said cross machine direction, thereby defining a plurality of qualitative values.

50. The method according to claim 49, wherein said predefined resolution is greater than 20×20 pixel per qualitative value.

51. The method according to claim 50, wherein said predefined pixel resolution is defined to image a predefined width of one of said at least two measuring points.

52. The method according to claim 51, wherein said predefined width is larger than 1 m.

53. The method according to claim 52, wherein different angles of reflection are simultaneously detected at least at one of said at least two measuring points and at each of said at least two measuring points.

54. The method according to claim 43, wherein said value characterizing said degree of reflection is detected as a value of a strength of a reflection.

55. The method according to claim 54, wherein said detecting step occurs continuously at each of said at least two measuring points.

56. The method according to claim 55, wherein said detecting step occurs at predefined time intervals.

57. The method according to claim 56, wherein said detecting step occurs on a moving surface.

58. The method according to claim 57, wherein said moving surface is a surface of a fibrous material web.

59. The method according to claim 58, wherein said at least one value characterizing said reflectivity is determined in a direction of travel of said fibrous material web at said at least two measuring points located at said distance from each other, said detecting step further including capturing a change in said reflectivity between said at least two measuring points.

60. The method according to claim 57, wherein said moving surface is a rotating surface, said rotating surface being at least one of a roll and a material web roll.

61. The method according to claim 43, wherein one of the at least one value characterizing the properties of the surface is gloss as a function of said degree of reflection.

62. The method according to claim 61, wherein one of the at least one value characterizing the properties of the surface is roughness as a function of said degree of reflection.

63. The method according to claim 62, wherein one of the at least one value characterizing the properties of the surface is at least one of a printability, blackening and fiber orientation, each of said printability, said blackening and said fiber orientation is a function of said degree of reflection.

64. A method for optimization of an operating mode of a material web treatment device for fibrous material webs, the method comprising the steps of:
illuminating at least two different measuring points on a surface of at least one of the material web and a component of the web treatment device with at least one emission source;
simultaneously detecting at least one value at least indirectly characterizing a reflectivity of said surface at said at least two different measuring points;
determining said at least one value at least indirectly characterizing properties of said surface of at least one of the fibrous material web and a component of the material web treatment device; and
setting said at least one value as an imput value for at least one of control and adjustment of an operating value characterizing the operating mode of the web treatment device.

65. The method according to claim 64, wherein said at least one value characterizing said reflectivity is a degree of reflection.

66. The method according to claim 65, further comprising the steps of:
detecting a change in said at least one value at least indirectly characterizing said properties of said surface of the fibrous material web; and
controlling the web treatment device according to said change in said at least one value at least indirectly characterizing said properties of said surface.

67. The method according to claim 66, further comprising the step of subjecting the fibrous material web in the material web treatment device to at least one of a change of temperature, a change of pressure, a moistening, and vaporization.

68. The method according to claim 67, wherein the web treatment device is a calender including a plurality of glazing cylinders forming a glazing nip.

69. The method according to claim 68, wherein said at least two measuring points are located on at least one of different glazing cylinders and different guide rolls of said calender.

70. The method according to claim 69, further comprising the step of producing a manipulated value defined by a variance of said at least one value at least indirectly characterizing said reflectivity from a set point for at least one of controlling and regulating an operating mode of at least one component of said calender, said at least one component of said calender including a steam blow box, a steam-water spray device, a water spray device, a roll temperature and a load in roll nip.

71. The method according to claim 70, further comprising the step of at least one of controlling and regulating a pressure profile of said load in roll nip.

72. The method according to claim 66, wherein the material web treatment device is a winder for a material web roll, said winder including a plurality of rolls, the method further comprising the steps of:
detecting at said at least one value at least indirectly characterizing said properties of said surface of at least one of a material web roll and one of said plurality of said rolls of said winder; and
using said at least one value as an input value for a control of said winder.

73. The method according to claim 72, wherein said plurality of rolls includes a carrier roll, the method further comprising the step of controlling one of a speed of said carrier roll and a contact pressure in a winding nip of said winder depending upon said at least one value.

74. The method according to claim 65, wherein said at least one value at least indirectly characterizing said reflectivity of said surface at said at least two different measuring points is detected with a detector device and said at least one emission source is an emission device relative to said detector device, said emission device being located at an angle less than 150° in relation to one of said at least two measuring points and a distance between said one measuring point and said detector device is greater than 5 m.

75. The method according to claim 74, further comprising the steps of:
pre-defining an initial state of said surface prior to starting the material web treatment device;
taking a measurement of said at least one value at least indirectly characterizing said reflectivity at said at least two measuring points, said at least one value having been measured defining a captured actual value; and
monitoring a relationship of said captured actual value in contrast to said initial state.

76. The method according to claim 75, wherein a plurality of values characterizing said initial state is freely defined.

77. The method according to claim 76, wherein said plurality of values characterizing said initial state of said surface are determined during adjustment of the material web treatment device, the method further comprising the step of producing an influence upon said surface of the material web with said plurality of values characterizing said initial state.

78. The method according to claim 75, wherein said step of pre-defining said initial state further comprises the steps of:
determining a plurality of actual initial state values during adjustment of the material web treatment device without the material web passing through said material web treatment device;
masking said at least two measuring points with a cover having a substantially homogenous surface characteristic; and
taking a reference measurement with said cover.

79. The method according to claim 75, wherein a plurality of values characterizing said initial state are utilized to describe a plurality of surfaces of a plurality of rolls not wrapped by the material web.

80. The method according to claim 79, further comprising the steps of:
continuously repeating a plurality of individual measurements of said at least one value characterizing said properties of said surface of said material web for correlation purposes; and
comparing said plurality of individual measurements with a plurality of measured values of a standard measuring system one of inside the material web treatment device and at a laboratory.

81. The method according to claim 80, further comprising the step of using at least one of said values characterizing said initial state, theoretical models and known experimental steady state characteristics to compensate a measuring result at said at least two measuring points for differences in a measuring geometry when considering more than one of said at least two measuring points with a detector device that is the same for each of said more than one of said at least two measuring points.

82. The method according to claim 81, further comprising the step of using at least one of a polarized light and a polarizing filter at predefined times prior to detecting said at least one value at least indirectly characterizing said reflectivity of said surface at said at least two different measuring points with said detector device.

83. The method according to claim 64, wherein said reflectivity of said surface of at least one of the material web and a component of the material web treatment device is evaluated at a plurality of one of wavelengths and spectra.

84. The method according to claim 83, further comprising the step of determining at least one value at least indirectly describing a quality of the material web from said reflectivity of said surface of the material web.

85. The method according to claim 84, wherein said at least one value at least indirectly describing the quality of the material web is at least one of gloss, smoothness, roughness, printability blackening and fiber orientation.

86. The method according to claim 85, further comprising the step of considering and linking relevant information including at least one of surface related dimensions, moisture, temperature, thickness, formation, composition, gloss, smoothness, roughness, printability, blackening, and fiber orientation as additional actual measured values from one of another measuring device and data sources to more precisely evaluate said at least one value at least indirectly describing the quality of the material web

87. An apparatus for detecting at least one value at least indirectly characterizing a surface in a material web treatment device, the apparatus comprising:
at least one emission source aimed at the surface; and
one detector device for measuring a reflectivity of the surface, said at least one emission source and said one detector device being together allocated to a plurality of measuring points.

88. The apparatus according to claim 87, wherein said emission device is located opposite said detector device at an angle less than 150° relative to one of said plurality of measuring points and a distance between said one of said plurality of measuring points and said detector device is greater than 5 m.
